(19) United States
(12) Patent Application Publication
(10) Pub. No.: US 2005/0038180 A1
(43) Pub. Date: Feb. 17, 2005

(54) Silicone elastomer material for high-resolution lithography

(76) Inventor: Albert H. Jeans, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/641,213

(22) Filed: Aug. 13, 2003

(51) Int. Cl. C08L 83/00

(52) U.S. Cl. 524/588; 524/858

(57) ABSTRACT

A method for making a high-resolution silicone elastomer material is disclosed. The method includes blending a base material of a DOW CORNING 93-500 Space Grade Encapsulant with a curing agent material of a DOW CORNING 93-500 Curing Agent in a ratio of about 8:1 by weight or by volume to form a silicone elastomer material. A fumed silica material of about 5.0% by weight of the base material is added to the silicone elastomer material and is then blended with the silicone elastomer material. The silicone elastomer material is then de-aired in a vacuum to remove entrained air. Optionally, after the de-airing, the silicone elastomer material can be blended. The resulting silicone elastomer material resists pairing and incipient pairing between adjacent sub-micron sized features.

### FIELD OF THE INVENTION

The present invention relates generally to a method for making a silicone elastomer material for use in making high-resolution molds of fine features, for use in imprint lithography, or the like. More specifically, the present invention relates to a method of making a silicone elastomer material comprising a base material of a DOW CORNING® 93-500 Space Grade Encapsulant and a curing agent of a DOW CORNING® 93-500 Curing Agent blended in a ratio of about 8:1 and further blended with a fumed silica material in a quantity of about 5.0% by weight of the base material. The resulting silicone elastomer material indefinitely resists pairing in fine feature size patterns that are formed in the silicone elastomer material by a molding process or an imprint lithography process.

### BACKGROUND OF THE INVENTION

Polydimethyl Siloxane (PDMS), a silicone-base elastomer material, is becoming widely used in micro imprint lithography and in other areas for making high-resolution molds of fine features. In particular, a DOW CORNING® silicone-based conformal coating, SYLGARD 184® silicone elastomer, is widely used because of its prevalence in the literature and its many useful characteristics including transparency to ultraviolet light, gas permeability, toughness, flexibility, and non-stick properties. Moreover, other silicone-based conformal coatings from DOW CORNING® that have properties similar to SYLGARD 184® have also been widely used for high-resolution molding of fine features and for micro imprint lithography. Those silicone-based conformal coatings include but are not limited to SYLGARD 182® silicone elastomer, SYLGARD 183® silicone elastomer, and SYLGARD 186® silicone elastomer.

SYLGARD 184® comes as a two-part epoxy consisting of a base or resin, and a curing agent, that are normally mixed in a ratio of 10:1 by weight or by volume. The two-part epoxy is in a liquid form so that the base and the curing agent can be easily mixed with each other to form the resulting silicone-based elastomer material. Curing of the SYLGARD 184® can occur at room temperature or can be accelerated by baking in an oven at a temperature of up to 120° C.

In FIG. 1, one disadvantage of prior silicone-base elastomer materials, such as SYLGARD 184®, SYLGARD 182®, SYLGARD 183®, and SYLGARD 186®, is that they exhibit limitations in replicating some fine feature lines when the feature size is about 0.5 μm or less. In particular, closely spaced line ridges 200L formed in SYLGARD 184® showed a strong tendency of adjacent ridges 200L to join or “pair”such that the ridges 200L bow inward 200B towards each other and connect with each other as indicated by the dashed region 200P. Further examination revealed that the pairing 200P was possibly due to a migration of lower molecular weight species within the SYLGARD 184® which would draw adjacent ridges 200L together. In FIG. 2, another form of pairing, incipient pairing 201P, can also occur between adjacent ridges 200L. Initially, in incipient pairing 201P, a small amount of the PDMS material (see dashed lines for 201P) bridges adjacent ridges 200L and causes those ridges 200L to bow slightly 200B towards each other. Over time, the adjacent ridges 200L will connect with each other as depicted in FIG. 1. Although the aforementioned pairing (200P, 201P) occurred with SYLGARD 184® for feature sizes of 0.5 μm or less, the pairing can also occur with other commercially available varieties of PDMS. Because the pairing comprises a defect in the features that are formed in the PDMS, it is desirable to eliminate pairing so that patterns replicated in the PDMS are defect free and accurately defined.

Consequently, there is a need for a method for making a silicone elastomer material that is well suited for replicating fine feature sizes, particularly feature sizes of about 0.5 μm or less, while indefinitely resisting pairing of adjacent features that are formed in the silicone elastomer material.

### SUMMARY OF THE INVENTION

Broadly, the present invention is embodied in a method for making a silicone elastomer material. The method includes adding a base material of a DOW CORNING® 93-500 Space Grade Encapsulant to a curing agent material of a DOW CORNING® 93-500 Curing Agent in a ratio of about 8:1 by weight or in a ratio of about 8:1 by volume. The base material and the curing agent are blended with each other (i.e. they are mixed with each other) in a mixing unit to form a silicone elastomer material. A fumed silica material, in a quantity of about 5.0% by weight of the base material, is added to the silicone elastomer material and is then mixed with the silicone elastomer material in the mixing unit. The fumed silica material can be a CAB-O-SIL® LM-130 fumed silica. Air bubbles entrapped in the silicone elastomer material are removed from the silicone elastomer material in a de-airing step wherein a vacuum is applied until substantially all of the air entrapped in the silicone elastomer material is removed. Optionally, after the de-airing step, the de-aired silicone elastomer material can again be blended in the mixing unit.

The resulting silicone elastomer material is well suited for replicating sub-micron feature size patterns. After a curing step, wherein the silicone elastomer material is heated in an oven or the like, the silicone elastomer material indefinitely resists pairing of adjacent sub-micron features.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a scanning electron microscope image of prior closely spaced PDMS line ridges that exhibit pairing between adjacent ridges.

FIG. 2 is a scanning electron microscope image of prior closely spaced PDMS line ridges that exhibit incipient pairing between adjacent ridges.

FIG. 3 is a flow diagram depicting a method for making a silicone elastomer material according to the present invention.

FIG. 4 is a flow diagram depicting a method for pouring a silicone elastomer material on a substrate according to the present invention.

FIG. 5 is a cross-sectional view depicting a mixing of a base material with a curing agent in a mixing unit to form a silicone elastomer material according to the present invention.

FIG. 6 is a cross-sectional view depicting adding a fumed silica material to a silicone elastomer material and mixing the fumed silica material with the silicone elastomer material according to the present invention.

FIG. 7 is a cross-sectional view depicting a silicone elastomer material after being poured onto a patterned substrate according to the present invention.

FIG. 8 is a cross-sectional view depicting a curing of a silicone elastomer material according to the present invention.

FIG. 9a is a cross-sectional view depicting a releasing of a silicone elastomer material from a patterned substrate according to the present invention.

FIG. 9b is a cross-sectional view of the silicone elastomer material of FIG. 9a with a pattern replicated therein according to the present invention.

FIG. 10 is a scanning electron microscope image of a plurality of patterns with submicron feature sizes that are formed in a silicone elastomer material without pairing between adjacent features according to the present invention.

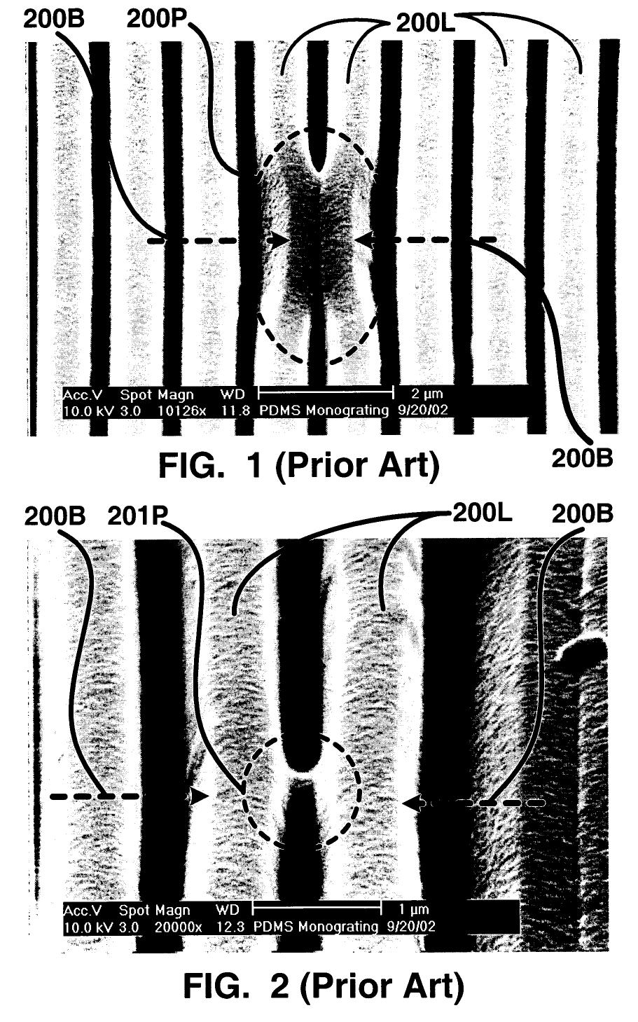

### DETAILED DESCRIPTION

In the following detailed description and in the several figures of the drawings, like elements are identified with like reference numerals.

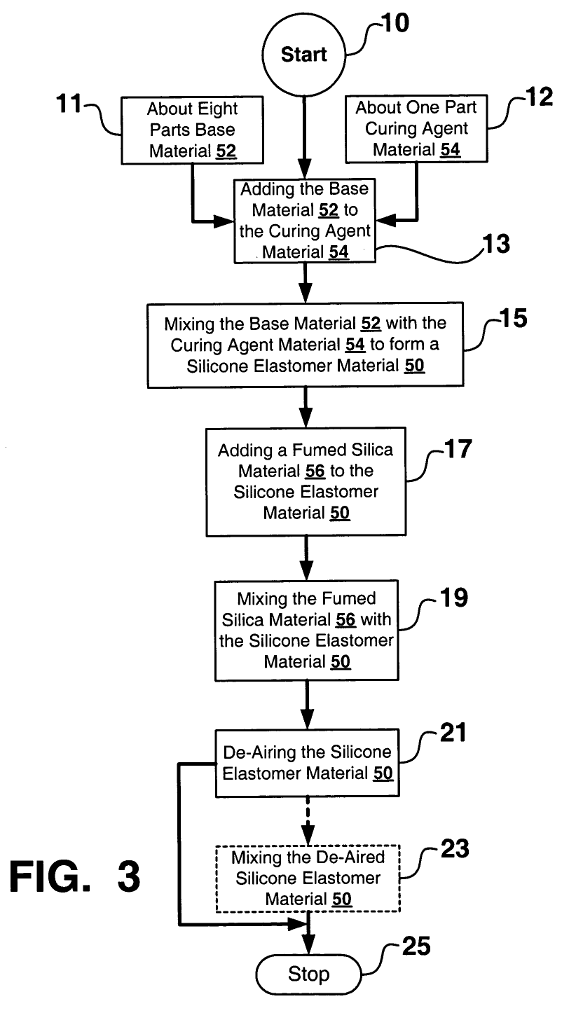

As shown in the drawings for purpose of illustration, the present invention is embodied in a method for making a silicone elastomer material. In FIG. 3, the method 10 includes adding 13 a base material 52 of a DOW CORNING® 93-500 Space Grade Encapsulant to a curing agent material 54 of a DOW CORNING® 93-500 Curing Agent. In steps 11 and 12, a predetermined amount of the base material 52 and the curing agent 54 are prepared so that the base material 52 is added 13 to the curing agent material 54 in a ratio of about 8.0 parts of the base material 52 to about 1.0 part of the curing agent 54. The base material 52 is then mixed 15 with the curing agent material 54 in a mixing unit (not shown) for a first predetermined time to form a silicone elastomer material 50. The predetermined amount of the base material 52 and the curing agent 54 can be by weight or by volume, that is, the ratio of about 8:1 of the base material 52 to the curing agent 54 can be by weight of those materials or by volume of those materials. Depending on the accuracy with which the weight or volume of the base material 52 and the curing agent 54 are measured, the ratio may not be exactly 8:1. Preferably, the ratio is substantially 8:1, that is, as close to exactly 8:1 as is possible.

A fumed silica material 56 is then added 17 to the silicone elastomer material 50 in a quantity of about 5.0% by weight of the base material 52. The fumed silica material 56 can be an untreated or a treated fumed silica material. Treated fumed silica materials have been chemically treated by the manufacturer to enhance one or more properties of the fumed silica material.

Preferably, the fumed silica material 56 is CAB-O-SIL® LM-130, a product manufactured by the Cabot Corporation®. CAB-O-SIL® LM-130 is an aerosol silica material that is a very light and fluffy powder comprising extremely small particles that have an enormous surface area. Accordingly, prior to the adding 17 of the fumed silica material 56 to the silicone elastomer material 50, an appropriate quantity of the CAB-O-SIL® LM-130 is measured out and weighed to obtain the aforementioned about 5.0% by weight of the base material 52. The fumed silica material 56 is then mixed 19 with the silicone elastomer material 50 in the mixing unit for a second predetermined time.

Depending on the accuracy with which the weight of the fumed silica material 56 is measured, the weight may not be exactly 5.0% by weight of the base material 52. Preferably, the ratio is substantially 5.0% by weight of the base material 52, that is, as close to exactly 5.0% by weight of the base material 52 as is possible.

After the mixing 19, the silicone elastomer material 50 is then de-aired 21 by applying a vacuum. The vacuum is applied until air entrapped in the silicone elastomer material 50 is removed. One indicator that entrapped air has been removed is the absence of air bubbles in the silicone elastomer material 50.

Optionally, to promote further de-airing of the silicone elastomer material 50, after the de-airing 21, the silicone elastomer material 50 can be mixed 23 (see dashed lines for step 23) in the mixing unit for a third predetermined time. The mixing 23 aids in the removal of air bubbles entrapped in the silicone elastomer material 50 that were not removed in the previous de-airing step 21. Particularly, the mixing 23 is effective in removing larger pockets of air that may be entrapped in the silicone elastomer material 50. Following the de-airing step 21 or the optional mixing step 23, the silicone elastomer material 50 can be used for a molding process, an imprint lithography process, or the like as will be described below.

The above mentioned first, second, and third predetermined times for the mixing (15, 19, 23) of the silicone elastomer material 50 will be application dependent. For example, an exemplary silicone elastomer material 50 was mixed using a time of about 15.0 seconds for the first, the second, and the third predetermined times. However, the first, second, and third predetermined times need not be identical and can vary. Moreover, it may be necessary to increase the first, second, and third predetermined times for large batches of the silicone elastomer material 50, especially if large quantities of the silicone elastomer material 50 are needed for a large scale manufacturing process. For the small quantities that are typically used in a small scale laboratory environment, the first, second, and third predetermined times can be in a range from about 10.0 seconds to about 25.0 seconds.

During the de-airing step 21, it is desirable to control the rate at which the vacuum is applied to the silicone elastomer material 50 so that the silicone elastomer material 50 does not foam. Foaming can result in the silicone elastomer material 50 spilling out of a container the silicone elastomer material 50 is mixed in. Preferably, the vacuum is applied gradually (i.e. slowly) for a fourth predetermined time to prevent foaming. The fourth predetermined time will be application dependent; however, the fourth predetermined time can be in a range from about 2.0 minutes to about 15.0 minutes.

Additionally, during the de-airing step 21, it is also desirable to slowly cycle the vacuum applied (i.e. modulate the vacuum by slowly ramping up and ramping down the amount of vacuum applied) to the silicone elastomer material 50 so that entrapped air bubbles that coalesce into larger pockets of entrapped air are removed over time as opposed to applying the vacuum at a constant rate, which can and result in those larger pockets of entrapped air not being completely removed during the de-airing step 21.

A magnitude of the vacuum applied to the silicone elastomer material 50 will be application dependent. However, an exemplary silicone elastomer material 50 was made using a magnitude of the vacuum of about 10.0 inches of mercury and that magnitude can be cycled, varied, or modulated over the fourth predetermined time to achieve the aforementioned removal of substantially all of the entrapped air.

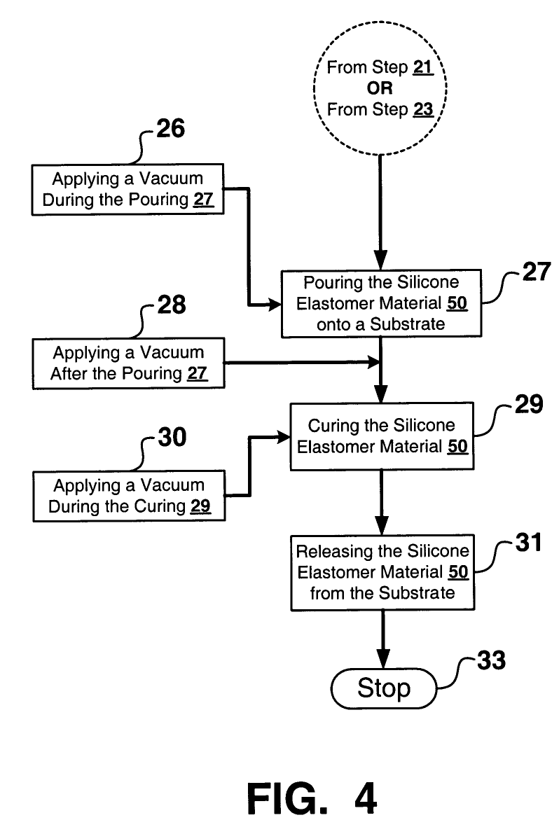

In FIG. 4, after the de-airing step 21 or after the mixing step 23 of FIG. 3, the silicone elastomer material 50 can be poured 27 onto a substrate (not shown). Preferably, the substrate includes a pattern to be transferred to the silicone elastomer material 50. The silicone elastomer material 50 is then cured 29 at a predetermined temperature for a fifth predetermined time. An oven or the like can be used to cure the silicone elastomer material 50. After the curing 29, the silicone elastomer material 50 is released 31 from the substrate so that the pattern carried by the substrate is replicated in (i.e. is transferred to) the silicone elastomer material 50.

The fifth predetermined time and the predetermined temperature for the curing 29 will be application dependent. The silicone elastomer material 50 can be cured at room temperature (e.g. about 25° C.) for about 24 hours; however, if cured at room temperature, the full mechanical and electrical strength of the silicone elastomer material 50 can take up to several days to be realized. For example, at a temperature of about 25° C., it can take about seven days for the silicone elastomer material 50 to cure. Consequently, it is preferable to cure the silicone elastomer material 50 at an elevated temperature. Care should be taken to ensure the predetermined temperature for the curing does not exceed a maximum curing temperature of the silicone elastomer material 50. Typically, the maximum curing temperature for PDMS is about 150° C. A manufacturers specification sheet for a specific formulation of PDMS should be consulted in order to determine the maximum curing temperature. The fifth predetermined time can be at least about 6.0 hours and the predetermined temperature can be about 80° C.

Optionally, in FIG. 4, to remove air entrapped between the silicone elastomer material 50 and the substrate, a vacuum can be applied 26 during the pouring 27 to remove entrapped air. The vacuum can be applied 26 for a length of time sufficient to ensure that all of the entrapped air has been removed. If the entrapped air is not removed, defects caused by pockets of air can be replicated in the silicone elastomer material 50 such that the pattern on the substrate is not accurately replicated in the silicone elastomer material 50. Alternatively, in FIG. 4, a vacuum can be applied 28 after the pouring 27 of the silicone elastomer material 50 to remove air entrapped between the silicone elastomer material 50 and the substrate.

One advantage of the method of the present invention is that the silicone elastomer material 50 can be used in molding and imprint lithography processes in which a feature size of the pattern to be replicated in the silicone elastomer material 50 can be less than about 0.5 μm. After the curing step 29 and the releasing step 31, adjacent patterns replicated in the silicone elastomer material 50 indefinitely resist pairing unlike the prior formulations of PDMS, such as the aforementioned prior formulations based on SYLGARD 184®, SYLGARD 182®, SYLGARD 183®, and SYLGARD 186®.

Another advantage of the method of the present invention is that the preparation of the silicone elastomer material 50 can be accomplished in a laboratory bench environment or in a large scale manufacturing environment.

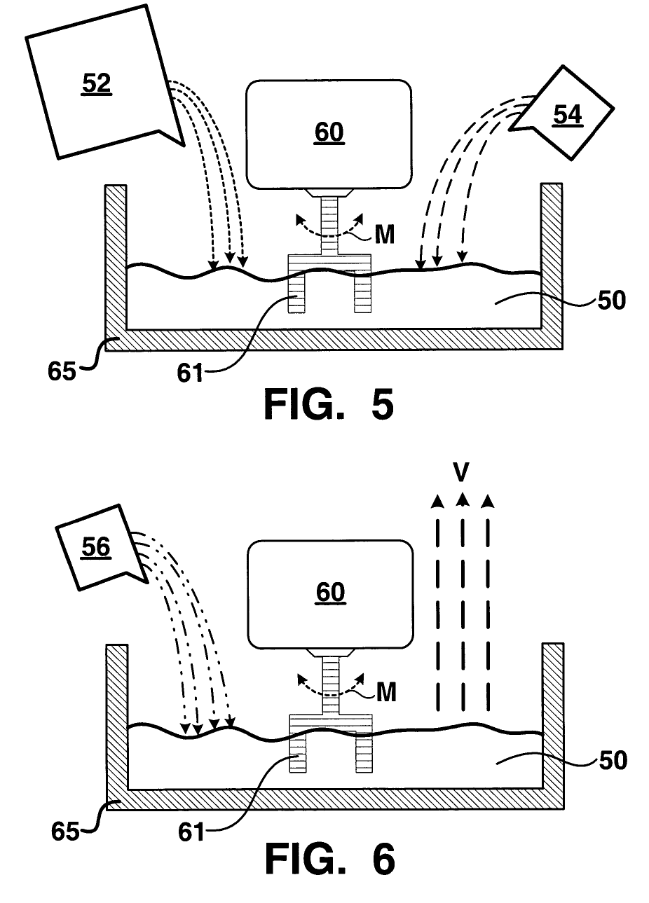

In FIG. 5, a container 65 can be used to contain the base material 52, the curing agent 54, and the fumed silica material 56 during the aforementioned mixing steps (15, 19, 23). Because the base material 52 and the curing agent 54 are in a liquid form, the container 65 typically will include a lid or the like (not shown) to prevent spilling or to prevent the materials (52, 54, 56) from being expelled from the container 65 during the mixing steps described herein.

As an example, a mixing unit 60 can include mixing blades 61 that are positioned inside the container 65 to blend the base material 52 with the curing agent 54 as they are added 13 to the container 65. For example, the blades 61 can be rotated in one direction or in a back and forth motion M to achieve the mixing. As the base material 52 and the curing agent 54 are mixed with each other, they form the silicone elastomer material 50.

Preferably, prior to adding 13 the base material 52 and the curing agent 54 to the container 65, the container 65 should be cleaned and dried to prevent contamination of the silicone elastomer material 50. The curing 29 of the silicone elastomer material 50 can be inhibited by contamination. The base material 52 and the curing agent 54 are supplied as a low viscosity liquid in separate containers. After measuring out the appropriate quantities of the base material 52 and the curing agent 54, by weight or by volume, the base material 52 and the curing agent 54 can be placed in separate, clean, dry, and contamination free containers and then added 13 to the container 65 by pouring the base material 52 and the curing agent 54 into the container 65.

The mixing unit 60 can be any apparatus for blending two or more materials with each other and the embodiments illustrated in FIGS. 5 and 6 are an example only and the method of the present invention is not limited to the embodiments illustrated herein. The mixing unit 60 can be a SpeedMixer®. The SpeedMixer® is a centrifugal type mixer that is well adapted to mixing small quantities of materials in a laboratory bench environment and is particularly well adapted for mixing the liquid base material 52 and the liquid curing agent 54 with each other. The SpeedMixer® mixes the base material 52 and the curing agent 54 in an enclosed container by spinning the container until the two liquids are homogeneously mixed with each other.

For larger scale mixing needs, other types of mixing units that are well known in the silicone elastomer and imprint lithography art can be used. For example, the mixing unit 60 may use mixing paddles or blades 61 as depicted in FIGS. 5 and 6 for mixing large quantities of the base material 52 and the curing agent 54 as part of a large scale manufacturing process. The speed at which the materials (52, 54, 56) are mixed will be application dependent and will depend on the type of mixing unit 60 used. The SpeedMixer® was run at a speed of about 2,000 revolutions per minute (RPM) to mix the base material 52 with the curing agent 54 during the aforementioned mixing steps (15,19, 23). The container 65 can be stationary during the mixing process or the container can be displaced or rotated relative to the mixing unit 60.

In FIG. 6, the fumed silica material 56 is added 17 to the silicone elastomer material 50 and then mixed 19 as was described above. A vacuum V such as a house vacuum or a vacuum supplied by a vacuum pump (not shown) can be used for the de-airing 21 of the silicone elastomer material 50. Optionally, after the de-airing 21, the silicone elastomer material 50 can be mixed 23. The mixing 23 can be at a speed of about 2,000 RPM and the mixing unit 60 can be the aforementioned SpeedMixer®.

The assembly depicted in FIGS. 5 and 6 can be positioned in a larger enclosure (not shown) that allows the vacuum V to be applied to the silicone elastomer material 50 for the de-airing 21. Alternatively, after the mixing 19, the container 65 can be placed in a separate vacuum chamber or the like to effectuate the de-airing 21. Preferably, the mixing 19 and the de-airing 21 occur in the same enclosure so that the container 65 need not be removed so that the silicone elastomer material 50 is not exposed to atmosphere thereby risking entrapment of air in the silicone elastomer material 50.

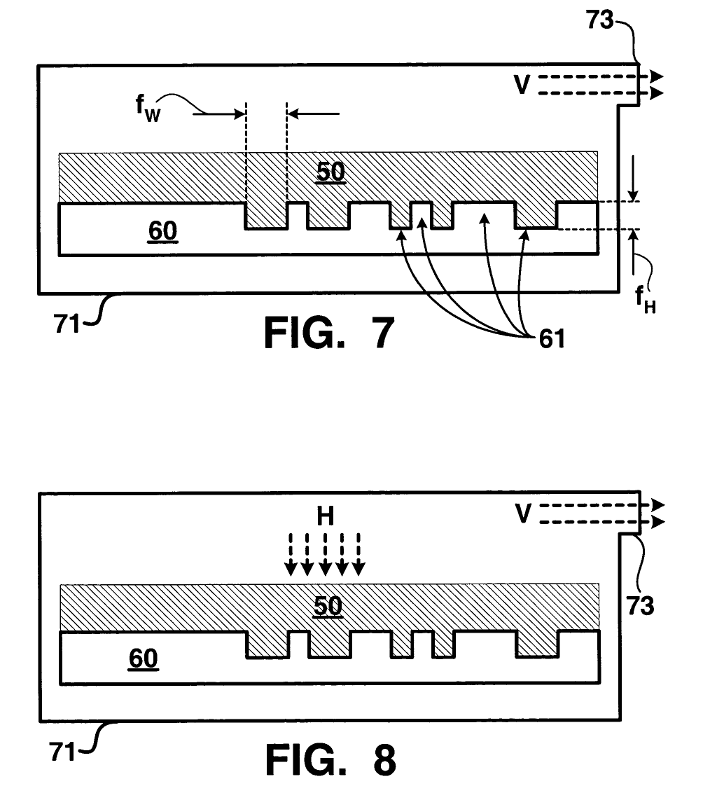

In FIG. 7, as described above in reference to FIG. 4, after the de-airing 21 or after the mixing 23 of the de-aired silicone elastomer material 50, the silicone elastomer material 50 can be poured 27 onto a substrate 60 that can include a pattern 61 to be transferred to the silicone elastomer material 50. The substrate 60 can be enclosed in chamber 71 that can be evacuated through a port 73 or the like to form a vacuum V in the chamber 71 so that air entrapped between the silicone elastomer material 50 and the substrate 60 can be removed during 26 the pouring 27 or after 28 the pouring 27 (see FIG. 4).

The patterns 61 formed on the substrate 60 can have a feature size that includes a feature height f_{H} and a feature width f_{W} that can be any size; however, the silicone elastomer material 50 of the present invention can be used to replicate patterns therein that have feature sizes (f_{H} and f_{W}) that are less than about 0.5 μm. The substrate 60 can be made from a variety of materials such as a silicon (Si) substrate or quartz, for example.

In FIG. 8, the silicone elastomer material 50 is cured 29 by applying heat H at a predetermined temperature for a fifth predetermined time. While the silicone elastomer material 50 is curing 29, the vacuum V can be applied during 30 the curing 29 (see FIG. 4) to ensure entrapped air is removed.

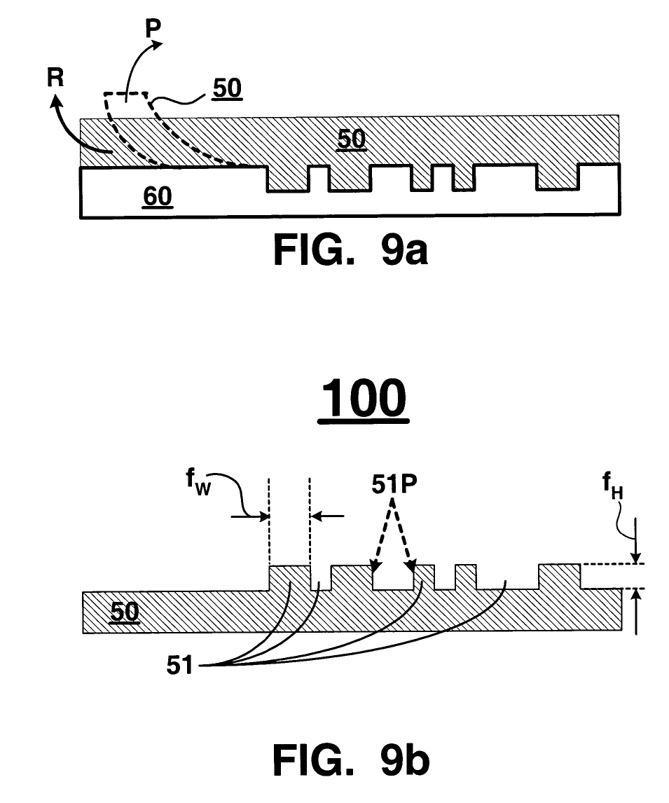

In FIG. 9a, after the curing 29, the silicone elastomer material 50 can be released 31 from the substrate 60. For instance, the silicone elastomer material 50 can be released 31 (see arrow R) by pealing P the silicone elastomer material 50 off of the substrate 60. The non-stick properties of the silicone elastomer material 50 allow for easy removal and peeling off of the silicone elastomer material 50 from the substrate 60. As described above, the fifth predetermined time can be at least about 6.0 hours and the predetermined temperature can be about 80° C. A pair of tweezers or an edge of a razor knife such as an X-ACTO® knife can be inserted between an interface between the substrate 60 and the silicone elastomer material 50 to effectuate the releasing 31.

In FIG. 9b, after the releasing step 31, a patterned silicone elastomer substrate 100 including the silicone elastomer material 50 and the patterns 51 is formed. The patterns 51 are a replica of the patterns 61 in the substrate 60. The patterns 51 also include the feature size (f_{H} and f_{W}) that can be any size including a feature size that is less than about 0.5 μm. Moreover, dashed arrows 51P denote an absence of pairing or incipient pairing between adjacent patterns 51.

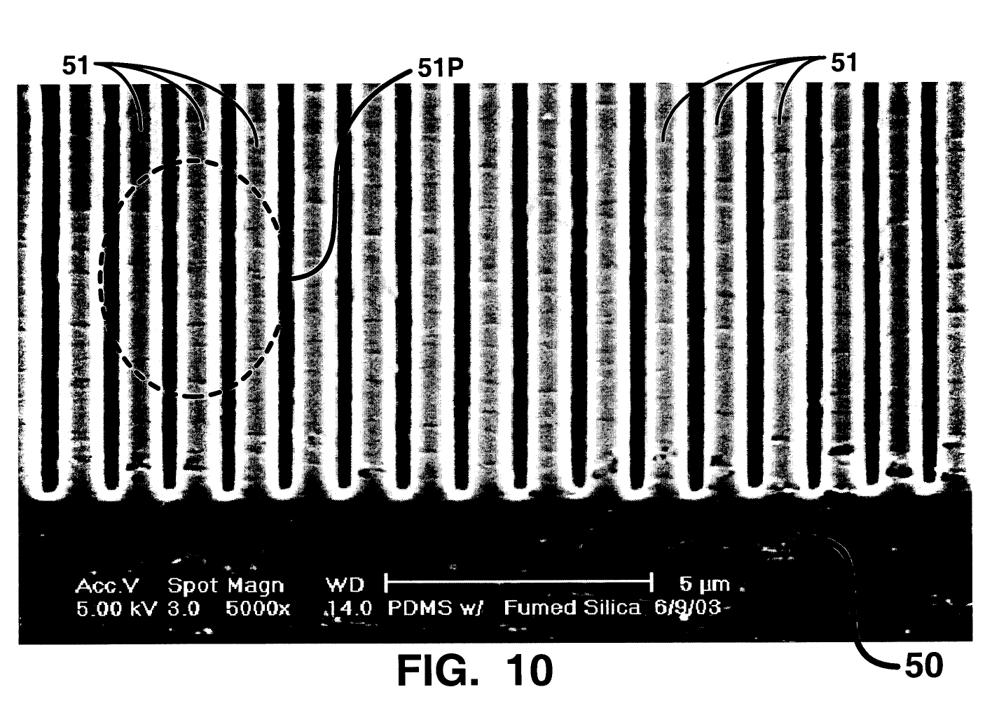

In FIG. 10, adjacent patterns 51 formed in the silicone elastomer material 50 are well defined and are devoid of pairing or incipient pairing (see 51P) and will indefinitely resist pairing. However, the silicone elastomer material 50 need not include the patterns 51 as depicted in FIGS. 9a and 9b and the silicone elastomer material 50 can be featureless (i.e. devoid of any patterns or features).

Another advantage of the silicone elastomer material 50 of the present invention is that it is flexible so that the patterned silicone elastomer substrate 100 can be conformally mounted to a variety of planar and non-planar surfaces, such as a cylindrical surface, and then used in an imprint lithography process wherein the patterns carried by the silicone elastomer substrate 100 are replicated in a media such as a layer of a photoresist material that is cured after the patterns 51 are imprinted therein.

An additional advantage of the silicone elastomer material 50 of the present invention is that it is optically transparent to some wavelengths of light, such as an ultraviolet wavelength of light. Accordingly, a substrate coated with a photoresist material that is urged into contact with the silicone elastomer material 50 or the patterned silicone elastomer substrate 100, can be exposed by an ultraviolet light source that irradiates the photoresist material through the silicone elastomer material 50 or the patterned silicone elastomer substrate 100 to cure the photoresist material.

Although several embodiments of an apparatus and a method of the present invention have been disclosed and illustrated herein, the invention is not limited to the specific forms or arrangements of parts so described and illustrated. The invention is only limited by the claims.

1. A method for making a silicone elastomer, comprising:
adding a base material of a 93-500 Space Grade Encapsulant to a curing agent material of a 93-500 Curing Agent in a ratio of about 8.0 parts of the base material to about 1.0 part of the curing agent;
mixing the base material with the curing agent in a mixing unit for a first predetermined time to form a silicone elastomer material;
adding a fumed silica material in a quantity of about 5.0% by weight of the base material to the to the silicone elastomer material;
mixing the fumed silica material and the silicone elastomer material in the mixing unit for a second predetermined time; and
de-airing the silicone elastomer material by applying a vacuum until air entrapped in the silicone elastomer material is removed.

2. The method as set forth in claim 1 and further comprising:
after the de-airing, mixing the de-aired silicone elastomer material in the mixing unit for a third predetermined time.

3. The method as set forth in claim 1, wherein the mixing unit comprises a SpeedMixer.

4. The method as set forth in claim 1, wherein the silicone elastomer material is mixed at a speed of about 2,000 revolutions per minute.

5. The method as set forth in claim 1, wherein the ratio of the base material to the curing agent is a selected one of about 8:1 by weight or about 8:1 by volume.

6. The method as set forth in claim 1, wherein the fumed silica material comprises CAB-O-SIL LM-130.

7. The method as set forth in claim 1, wherein the fumed silica material is a selected one of an untreated fumed silica material and a treated fumed silica material.

8. The method as set forth in claim 1, wherein the first predetermined time, the second predetermined time, and the third predetermined time are in a range from about 10.0 seconds to about 25.0 seconds.

9. The method as set forth in claim 1, wherein the vacuum is applied gradually for a fourth predetermined time to prevent foaming of the silicone elastomer material.

10. The method as set forth in claim 9, wherein the fourth predetermined time is in a range from about 2.0 minutes to about 15.0 minutes.

11. The method as set forth in claim 1, wherein the ratio of the base material to the curing agent is substantially 8:1.

12. The method as set forth in claim 1, wherein the vacuum applied to the silicone elastomer material has a magnitude of about 10.0 inches of mercury.

13. The method as set forth in claim 1, wherein a magnitude of the vacuum applied to the silicone elastomer material is modulated over the fourth predetermined time.

14. The method as set forth in claim 1, wherein the quantity of the fumed silica material is substantially 5.0% by weight of the base material.

15. The method as set forth in claim 1 and further comprising:
after a selected one of the de-airing of the silicone elastomer material or the mixing of the de-aired silicone elastomer material, pouring the silicone elastomer material onto a substrate that includes a pattern to be transferred to the silicone elastomer material;
curing the silicone elastomer material at a predetermined temperature for a fifth predetermined time; and
releasing the silicone elastomer material from the substrate.

16. The method as set forth in claim 15 and further comprising applying a vacuum during the pouring to remove air entrapped between the substrate and the silicone elastomer material.

17. The method as set forth in claim 15 and further comprising applying a vacuum after the pouring to remove air entrapped between the substrate and the silicone elastomer material.

18. The method as set forth in claim 15 and further comprising applying a vacuum during the curing to remove air entrapped between the substrate and the silicone elastomer material.

19. The method as set forth in claim 15, wherein the fifth predetermined time is at least 6.0 hours.

20. The method as set forth in claim 15, wherein the predetermined temperature is about 80.0 degrees centigrade.

21. The method as set forth in claim 15, wherein the pattern includes a feature size that is less than about 0.5 micrometers.

22. A patterned silicone elastomer substrate, comprising:
a base material of a 93-500 Spac Grad Encapsulant;
a curing agent material of a 93-500 Curing Agent, the base material and the curing agent material are combined in a ratio of about 8.0 parts of the base material to about 1.0 part of the curing agent;
a fumed silica material in a quantity of about 5.0% by weight of the base material; and
a plurality of patterns formed in the silicone elastomer substrate.

23. The patterned silicone elastomer substrate as set forth in claim 22, wherein the fumed silica material comprises CAB-O-SIL LM-130.

24. The patterned silicone elastomer substrate as set forth in claim 22, wherein the ratio of the base material to the curing agent is substantially 8:1.

25. The patterned silicone elastomer substrate as set forth in claim 22, wherein the quantity of the fumed silica material is substantially 5.0% by weight of the base material.

26. The patterned silicone elastomer substrate as set forth in claim 22, wherein the patterns include a feature size that is less than about 0.5 micrometers.

27. A silicone elastomer material, comprising:
a base material of a 93-500 Space Grade Encapsulant;
a curing agent material of a 93-500 Curing Agent, the base material and the curing agent material are combined in a ratio of about 8.0 parts of the base material to about 1.0 part of the curing agent; and
a fumed silica material in a quantity of about 5.0% by weight of the base material.

28. The silicone elastomer material as set forth in claim 27, wherein the fumed silica material comprises CAB-O-SIL LM-130.

29. The silicone elastomer material as set forth in claim 27, wherein the ratio of the base material to the curing agent is substantially 8:1.

30. The silicone elastomer material as set forth in claim 27, wherein the quantity of the fumed silica material is substantially 5.0% by weight of the base material.
